(19) United States
(12) Patent Application Publication
(10) Pub. No.: US 2022/0364669 A1
(43) Pub. Date: Nov. 17, 2022

(54) Lockout Device

(71) Applicant: Aqua Lockout, Devon (CA)

(72) Inventors: Bradley Hamilton, Granville Ferry (CA); Jamie Decker, Devon (CA); Michael E. Hamilton, Edmonton (CA); Brent Love, St Albert (CA); Kenneth J. Wildeboer, Ardrossan (CA)

(73) Assignee: Aqua Lockout, Edmonton, AB (CA)

(21) Appl. No.: 17/770,843

(22) PCT Filed: Oct. 23, 2020
(86) PCT No.: PCT/IB2020/059999

§ 371 Date: Apr. 21, 2022

Related U.S. Application Data
(60) Provisional application No. 62/924,750, filed on Oct. 23, 2019.

(51) Int. Cl. F16L 55/11; E05B 67/36

(52) U.S. Cl. CPC F16L 55/1125; E05B 67/36

(57) ABSTRACT

A lockout system and method are provided. The lockout system prevents unauthorized and inadvertent operation of any system requiring energy isolation by locking out and tagging out the controls. The lockout system includes a housing and a twist member that allows for selective configuration of the lockout system between a release and retention configuration. In the release configuration, the lockout system is adapted to be selectively positioned within the pipe and removed from the pipe. In the retention configuration, the lockout system is semi-permanently secured to the interior of the pipe via an engagement member. The housing and the twist member each comprise an aperture sized to align and receive a lock wherein once received the twist member is cooperatively secured to the housing via the lock in a locked configuration. In the locked configuration, the lockout system is secured to the pipe and prevents access to the pipe.

### CROSS REFERENCE TO RELATED APPLICATION

This application claims the benefit of U.S. Provisional Application No. 62/924,750 filed on Oct. 23, 2019. The above identified patent application is herein incorporated by reference in its entirety to provide continuity of disclosure.

### BACKGROUND OF THE INVENTION

The present invention relates to a lockout/tagout device. The present invention further provides a lockout device that is securable to a hydraulic pipe to prevent access to an interior valve or the like. A bracket of the lockout device forms an arrangement with a lock to secure the lockout device in a locked position.

“Lockout/tagout” refers to specific practices and procedures to safeguard professionals from the unexpected energization or startup of machinery and equipment, or the release of hazardous energy during service or maintenance activities. For example, Occupational Safety and Health Administration (OSHA) and Occupational Health and Safety (OHS) have standards related to Hazardous Energy Isolation. Generally, they require that hazardous energy sources be (1) identified, (2) isolated, and (3) rendered inoperative to prevent the release of potentially hazardous energy prior to the start of any repair or maintenance procedure. The present invention provides a system and method that assists with the compliance of the guidelines of the various health and safety agencies.

The lockout/tagout procedure is often required to prevent accidental tampering with hydraulic, pneumatic, or electrical system. For example, a maintenance worker rendering repairs to a hydraulic system is required by appropriate regulations to render the working condition safe. As a solution, some companies simply insert a plug that covers the pipe without applying a lock to it. Unfortunately, the failure to control access to the pipe via a lock renders the pipe vulnerable to tampering, accidental or not.

The present invention relates to a lockout/tagout device and more particularly pertains to a new lockout/tagout system and method for preventing access to the interior valve or the like of a hydraulic pipe.

The present invention provides a lockout/tagout system that utilizes a housing, a twist member, and an engagement member for securing a hydraulic pipe. The system engages the interior of the pipe through either expansion or rotation of the engagement member. Once engaged, the pipe is secured and safe for maintenance or service activities. Additionally, a lock, such as a padlock, may be applied to the housing and/or twist member to ensure the hydraulic pipe remains in the locked position. The secure padlock feature prevents unauthorized or inadvertent activation of the hydraulic pipe, ensuring the safety of workers and the like. The design and function of this device coupled with its added safety measures improves upon past inventions and greatly limits the hazards of maintenance activities.

In light of the devices disclosed in the known art, it is submitted that the present invention substantially diverges in design elements and methods from the known art and consequently it is clear that there is a need in the art for an improvement for lockout/tagout devices. In this regard the instant invention substantially fulfills these needs.

### SUMMARY OF THE INVENTION

In view of the foregoing disadvantages inherent in the known types of lockout devices now present in the known art, the present invention provides a new lockout device wherein the same can be utilized for securing to an open end of a pipe.

It is an objective of the present invention to prevent unauthorized and inadvertent operation of the valve, and more particularly, to a system for locking out and tagging out any system requiring energy isolation including, but not limited to, electrical circuit breakers, disconnect switches, ball or gate valves, blind flanges, and blocks.

In one embodiment, the lockout system provides for controlling access to an interior of a pipe via an open end thereof. The lockout system provides various embodiments of the lockout system including the Arizona design, Montreal design, and Winnipeg design. These designs are adapted for use with various valve box styles, wherein the valve box styles have differing designs.

The lockout system comprises a housing sized to be seated within the pipe to cover the open end thereof. A twist member is provided in relation to the housing and allows for selective configuration of the lockout system between a release configuration and a retention configuration. The twist member is independently rotatable from the housing to transition between the release and retention configurations. In the release configuration, the lockout system is adapted to be selectively positioned within the pipe and removed from the pipe. In the retention configuration, the lockout system is semi-permanently secured to the interior of the pipe via an engagement member, such that the housing substantially closes access to the pipe.

In one embodiment, the housing and the twist member each comprise an aperture sized to align and receive a shackle of a lock wherein once received the twist member is cooperatively secured to the housing via the lock in a locked configuration so as to prevent independent rotation of the twist member. In the locked configuration, the lockout system is secured to the pipe and prevents access to the pipe and at the underside of the housing.

In one embodiment, the engagement member is a dog plate having a shaft aperture, wherein the shaft extends through the shaft aperture and through a track of a frame plate. The dog plate is pivotally connected to the housing at a pivot such that the dog plate is adapted to rotate about the pivot, wherein rotation of the handle causes cooperative rotation of the base plate, such that the dog plate extends and retracts corresponding to the rotation. In this way, the dog plate bears against the pipe and is selectively used to lock the lockout system to the pipe.

In another embodiment, the twist member comprises a handle disposed on an upper side and a shaft extends from a lower side of the twist member to the engagement member, wherein the engagement member is an engagement bar. The rotation of the handle causes cooperative rotation of the engagement bar; thus, the lockout system is selectively used to lock the lockout system to the pipe.

In yet another embodiment, the twist member is a dial rotatable about a shaft housing such that the dial is configured to cooperatively rotate the shaft housing and cause a shaft operably connected within the shaft housing to selectively extend and retract. The shaft extends from the shaft housing and is adapted to frictionally bear against an interior of the pipe to semi-permanently affix the housing to the pipe in a retention configuration.

In yet another embodiment, the dial includes one or more dial apertures each adapted to receive a shank of a lock therethrough. Once the lock is received through one or more of the dial apertures disposed on the upper side of the plate, the dial is cooperatively secured to the housing via the lock in a locked configuration so as to prevent independent rotation of the dial.

In yet another embodiment, the locking system comprises a housing sized to be seated within the pipe to cover the open end thereof. The housing includes an annular ring extending from a perimeter forming an open upper end and a top plate seated within the housing and recessed from the open upper end of the ring. The housing may also include a sidewall having one or more lateral slots and the top plate having one or more latches corresponding to the one or more lateral slots. The housing includes a channel extending from a lower end to the ring, wherein the channel is sized to receive a shoulder of a pipe therein. The top plate is adapted to rotate between a release configuration and a retention configuration, wherein the release configuration the top plate is positioned within the slot allowing the shoulder to be positioned within the channel and wherein the retention configuration the latch is positioned within the channel to sandwich the shoulder between the ring and the latch thereby semi-permanently securing the housing to the pipe.

In yet another embodiment of the present invention, a method of lockout and tagout of a pipe is provided. The method includes providing a lockout system comprising one embodiment of the lockout system, positioning the lockout system within the pipe so as to cover the open end thereof; and actuating the twist member such that the lockout system transitions from the release configuration to the retention configuration, wherein the retention configuration an engagement member is semi-permanently secured to the interior of the pipe and wherein apertures of the housing and the twist mechanism are aligned. Mover, the method may include securing a lock to the housing and the twist mechanism via the apertures in a locked configuration such that the lockout system is secured to the pipe and prevents access to the pipe and at the underside of the housing.

It is therefore an object of the present invention to provide a new and improved lockout device that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of the lockout system installed within to a first style valve box.

FIG. 2 shows a perspective view of a first embodiment of the Arizona design of the lockout system installed within a second style valve box.

FIG. 3 shows an overhead view of the first embodiment of the Arizona design of the lockout system.

FIG. 4 shows a cross sectional view of the first embodiment of the Arizona design of the lockout system taken along line 4-4 of FIG. 3.

FIG. 5 shows a cross sectional view of the first embodiment of the Arizona design of the lockout system taken along line 5-5 of FIG. 3.

FIG. 6 shows a perspective view of a second embodiment of an Arizona design of the lockout system.

FIG. 7 shows an overhead view of the second embodiment of the Arizona design of the lockout system.

FIG. 8 shows a cross sectional view of the second embodiment of the Arizona design of the lockout system taken along line 8-8 of FIG. 7.

FIG. 9 shows a perspective view of a first embodiment of a Montreal design of the lockout system installed within a third style valve box.

FIG. 10 shows an exploded view of the first embodiment of the Montreal design of the lockout system.

FIG. 11 shows a cross sectional view of the third embodiment of the Montreal design of the lockout system taken along line 11-11 of FIG. 10.

FIG. 12 shows a cross sectional view of the third embodiment of the Montreal design of the lockout system taken along line 12-12 of FIG. 10.

FIG. 13 shows a perspective view of a first embodiment of a Winnipeg design of the lockout system.

FIG. 14 shows another perspective view of a first embodiment of the

Winnipeg design of the lockout system.

FIG. 15 shows an overhead view of a first embodiment of the Winnipeg design of the lockout system.

FIG. 16 shows a side view of a first embodiment of the Winnipeg design of the lockout system.

FIG. 17 shows an underside view of a first embodiment of the Winnipeg design of the lockout system.

FIG. 18 shows a cross sectional view of a first embodiment of the Winnipeg design of the lockout system taken along line 18-18 of FIG. 15 and installed to a fourth style valve box.

FIG. 19 shows cross sectional view of a first embodiment of the Winnipeg design of the lockout system taken along line 19-19 of FIG. 18 and installed to a fourth style valve box.

### DETAILED DESCRIPTION OF THE INVENTION

Reference is made herein to the attached drawings. For the purposes of presenting a brief and clear description of the present invention, the preferred embodiment will be discussed as used for securing to a hydraulic pipe opening during maintenance or other operations known as lockout/tagout procedure. The figures are intended for representative purposes only and should not be considered to be limiting in any respect.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment. Additionally, “lockout system”, “lockout device”, and “tagout device” may be used interchangeably and both refer to the present invention.

References to the various embodiments of the lockout system includes the Arizona design, Montreal design, and Winnipeg design. These designs are adapted for use with various valve box styles, wherein the valve box styles have differing designs.

References to “valve boxes” or “pipes” are understood to include, and is not limited to, forms of energy isolation include electrical circuit breakers, disconnect switches, ball or gate valves, blind flanges, and blocks. For example, a valve box style may include a flange extending inward from an interior thereof, wherein the flange extends partially around the entire interior side. A first style valve box may provide the flange several centimeters from the open end, and a second style valve box may provide the same flange but have the position further or closer to the open end. Yet, other valve boxes may have various geometries and dimensions that are suitable for the various uses.

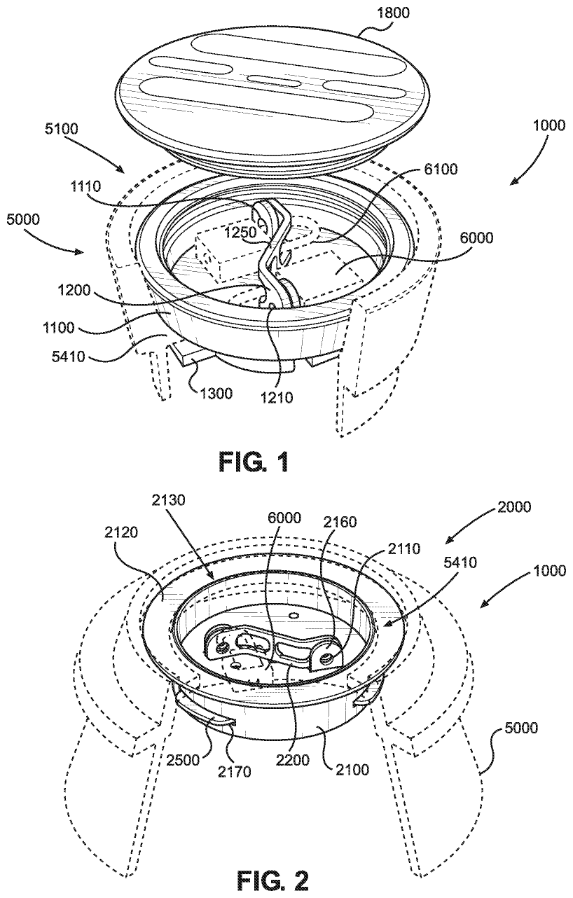

Referring now to FIG. 1, there is shown a perspective view of the lockout system installed within a first style valve box, respectively. The lockout system provides for controlling access to an interior of a pipe via an open end thereof. In the shown embodiment, the pipe 5000 comprises a first style valve box. In this style, the pipe 5000 includes an internal flange 5410 for securing therewith. The internal flange 5410 partially extends around an inner circumference of the pipe. The lockout system 1000 comprises a housing 1100 sized to be seated within the pipe (or “valve box”) 5000 to cover the open end 5100 thereof. The housing 1100 is generally sized to fit within the circumference of the open end 5100 such that an upper end of the housing 1100 is seated on a plane of the open end 5100. In some embodiments, the upper end of the housing 1100 is positioned above or below the open end 5100. A twist member 1200 of the lockout system 1000 provides for selectively configuring the lockout system between a release configuration and a retention configuration. The twist member 1200 is independently rotatable from the housing 1100, and generally secured to the housing 1100 to allow for degrees of rotation. In the shown embodiment, the twist member 1200 is secured to the housing 1100 via a pin that extends through the housing 1100, while remaining free to rotate about the pin. However, in alternate embodiments, the twist member is rotatably secured to the housing in any suitable manner.

In the retention configuration, the lockout system 1000 is semi-permanently secured to the interior of the pipe 5000 via an engagement member 1300, such that the housing 1100 substantially closes access to the pipe 5000. The engagement member 1300 is operably connected to the twist member 1200, such that the twist member 1200 selectively positions the engagement member 1300 as desired. The position of the engagement member 1300 and the style of pipe 5000 cooperatively provide for the coupling thereof and the semi-permanent connection between the housing 1100 and the pipe 5000. As described above, the style of pipe 5000 can vary from use to use, and therefore the engagement member 1300 structure and means of securing to the specific style of pipe 5000 is particular to each embodiment, such as the Arizona design, Montreal design, and the Winnipeg design. However, despite that the illustrated embodiments are shown and described as engaging with a particular style of valve box, the characterization does not preclude an illustrated embodiment from locking or engaging with a different style of valve box.

In the release configuration, the lockout system 1000 is adapted to be selectively positioned within the pipe 5000 and removed from the pipe 5000. In this way, the housing 1100 and engagement member 1300 are configured to not engage with each other so as to semi-permanently secure. In this way, the user may actuate the twist member 1200 to reposition the engagement member 1300 so as to effectuate removal of the housing 1100 from the pipe 5000.

In the shown embodiment, the housing 1100 and the twist member 1200 each further comprising an aperture 1110, 1210 sized to align and receive a shackle 6100 of a lock 6000 wherein once received the twist member 1200 is cooperatively secured to the housing 1100 via the lock 6000 in a locked configuration so as to prevent independent rotation of the twist member 1200. In the shown embodiment, the housing and twist member apertures 1110, 1210 are positioned at an upper end of the housing 1100. When the housing and twist member apertures 1110, 1210 are moved to be flush and adjacent, the twist member 1210 causes the engagement member 1300 to the retention configuration. When the lock 6000 is secured to the housing and twist member apertures 1110, 1210, the position is now in the locked position. In the locked configuration, the lockout system 1000 is secured to the pipe 5000 and prevents access to the pipe 5000 and at the underside of the housing 1100. In some embodiments, a cover 1800 is removable from the housing 1100 and adapted to be seated within a lip of the housing 1100 to cover the twist member 1200. The cover 1800 may include information related to the pipe, lockout system, inspection dates, and the like. In the shown embodiment, the cover is adapted to sit flush with the distalmost edge of the cylindrical housing 1100.

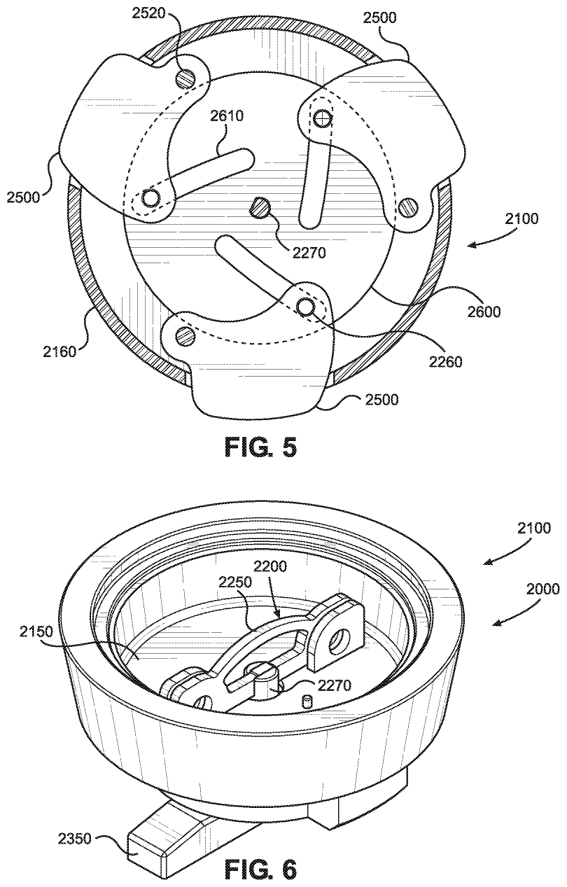

Referring specifically to FIGS. 2-5, there are shown views of a first embodiment of the Arizona design 2000. In the shown embodiment, the pipe 5000 comprises a second style valve box. In this style, the pipe 5000 includes an internal flange 5410 (shown in broken lines) disposed towards the open end of the pipe 5000 for securing to the lockout housing 2100. The lockout system 1000 enables a user to selectively render a hydraulic pipe 5000 safe by inserting the lockout housing 2100 therein, securing the lockout housing 2100 to the interior of the hydraulic pipe 5000, and applying an external lock 6000 to the lockout housing 2100 and twist member 2200 in such a manner that the lockout housing 2100 cannot be removed from the pipe 5100 without removal of the external lock 6000.

In the illustrated embodiment, the lockout system includes a twist member 2200 having a handle 2250 disposed on an upper side and a pin 2270 that extends through the housing 2100 from a lower side of the twist member 2200 to a base plate 2400. The engagement member 2300 comprises a dog plate 2500 having a shaft aperture 2510, wherein the shaft 2260 extends through the shaft aperture 2510 and through a track 2610 of a frame plate 2600. The dog plate 2500 is pivotally connected to the housing 2100 at a pivot 2520 such that the dog plate 2500 is adapted to rotate about the pivot 2520. In one exemplary use, rotation of the handle 2250 causes cooperative rotation of the base plate 2400, such that the dog plate 2500 extends and retracts corresponding to the rotation. In this way, the dog plate 2500 is adapted to slide along the track 2610 while rotating about the pivot 2520.

In the shown embodiment, the housing 2100 includes a sidewall 2160 having a slot 2170 sized to receive the engagement member 2300 (dog plate 2520) therethrough. In the shown embodiment, the Arizona design embodiment includes three dog plates 2500 that correspond to an equal number of tracks 2610, and housing slots 2170. In alternative embodiments, dog plate 2500 may include one or more. In yet other alternative embodiments, the number of corresponding tracks 2610 and housing slots 2170 may be more or less than the number of dog plates 2500. In the illustrated embodiment, the dog plates 2500 are equidistance apart from one another.

In the shown Arizona embodiment, the housing 2100 comprises a lip 2120 extending from a perimeter forming an open upper end 2130 and a top plate 2150 seated within the lip 2120 and recessed from the open upper end 2130 of the lip 2120. The top plate 2150 includes a tab 2160 extending vertically therefrom, wherein the tab 2160 includes an aperture 2110 adapted to align with the handle 2250 having an aperture 2210, wherein each aperture 2110, 2210 is sized to receive a shackle 6100 of the lock 6000. The handle 2250 is operably connected to the pivot pin 2270 that extends through the top plate 2150 and secures the handle 2250 to the top plate 2150, while providing for rotation of the handle about the pin 2270.

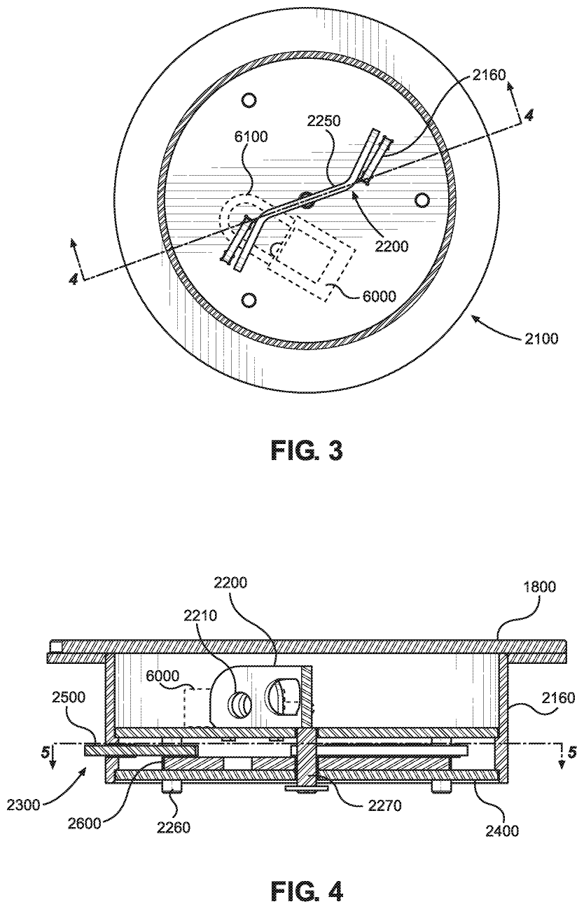

In the illustrated embodiment, the tab 2610 comprises a pair of tabs 2610 extending perpendicular from top plate 2150. Moreover, the pair of tabs 2610 are positioned offset from each other, on opposing sides of the top plate 2150, and along parallel planes (as shown in FIG. 3), such that the handle 2250 has a length that extends between the offset. In this way, the tabs 2610 function to stop the handle 2250 from over rotating, and guide the handle 2250 to a desired position, such that the housing 2100 is in the retention configuration when the handle 2250 bears against the effacing sides of the tabs 2610.

In the shown embodiment, the handle 2250 comprises a straight portion and a pair of angled end portions, such that a pair of padlocks 6000 are adapted to fit on the upper sides thereof. In one embodiment, the pair of angled end portions extend diagonally in opposite directions from one another before forming an angle between sixty and one hundred and twenty degrees with the straight portion. However, the angle may form any angle suitable for the lock to secure thereto. In alternative embodiments, the handle 2250 may comprise only a straight portion as shown in FIG. 6.

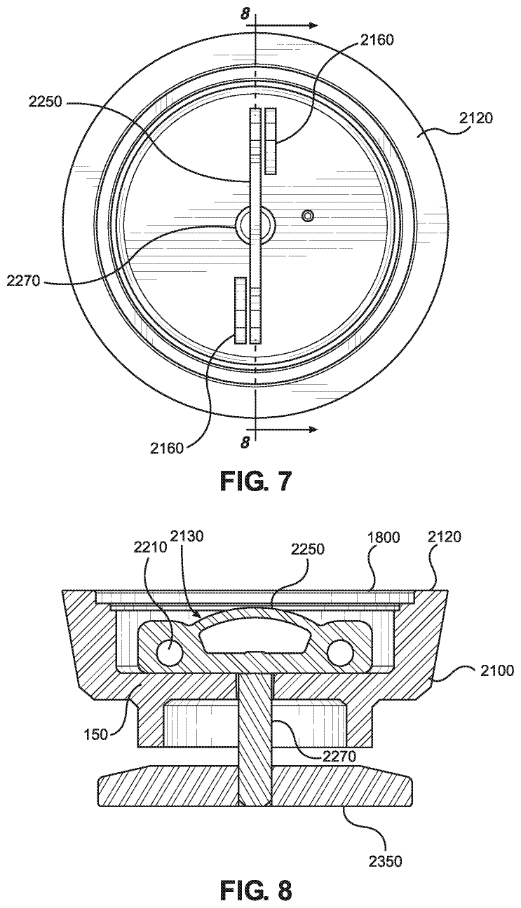

Referring specifically to FIGS. 6-8, there are shown views of a second embodiment of the Arizona design 2000. In the illustrated embodiment of the lockout system 2000, the twist member 2200 comprises a handle 2250 disposed on an upper side of the top plate 2150 and a pin 2270 that extends from a lower side of the twist member 2200 to the engagement member 2300. As shown, the engagement member 2300 is an engagement bar 2350. The engagement bar 2350 is generally straight and disposed on a single axis. The engagement bar 2350 is adapted to rotate cooperative with rotation of the handle 2250. As shown in FIG. 8, the pin 2270 joins the handle 2250 and the engagement bar 2350 such that they are fixed to each other. Moreover, the lengths of the orientation of the handle 2250 and the engagement bar 2350 are disposed along the same plane. In this way, the user knows the position of the engagement bar 2350 when the housing 2100 is received within the pipe without needed to have direct vision of the engagement bar 2350.

In the shown embodiment, the engagement bar 2350 is adapted to fit underneath an interior shoulder 5410 of a pipe 5000. Since the interior shoulder 5410 of a pipe 5000 only extends partially therearound, the diameter of the pipe 5000 absent the shoulder 5410 is greater than the length of the engagement bar 2350. Thus, the engagement bar 2350 can be positioned underneath the interior shoulder 5410 to semi-permanently securing the housing 2100 to the pipe 5000. This is shown best in FIG. 1, where the embodiment shown includes the engagement bar 2350.

In the shown second embodiment of the Arizona design, the housing 2100 comprises a lip 2120 extending from a perimeter forming an open upper end 2130 and a top plate 2150 seated within the lip 2120 and recessed from the open upper end 2130 of the lip 2120. The top plate 2150 includes a tab 2160 extending vertically therefrom, wherein the tab 2160 includes an aperture 2110 adapted to align with the handle 2250 having an aperture 2210, wherein each aperture 2110, 2210 is sized to receive a shackle 6100 of the lock 6000. The handle 2250 is operably connected to the pivot pin 2270 that extends through the top plate 2150 and secures the handle 2250 to the top plate 2150, while providing for rotation of the handle about the pin 2270.

In the shown second embodiment of the Arizona design, the tab 2160 comprises a pair of tabs 2160 extending perpendicular from top plate 2150. Moreover, the pair of tabs 2160 are positioned offset from each other, on opposing sides of the top plate 2150, and along parallel planes (as shown in FIG. 3), such that the handle 2250 has a length that extends between the offset. In this way, the tabs 2160 function to stop the handle 2250 from over rotating, and guide the handle 2250 to a desired position, such that the housing 2100 is in the retention configuration when the handle 2250 bears against the effacing sides of the tabs 2160.

In the shown embodiment, the handle 2250 comprises only a straight portion. In alternative embodiments, the handle 2250 may include a straight portion and a pair of angled end portions, such that a pair of padlocks 6000 are adapted to fit on the upper sides thereof. In one embodiment, the pair of angled end portions extend diagonally in opposite directions from one another before forming an angle between sixty and one hundred and twenty degrees with the straight portion. However, the angle may form any angle suitable for the lock to secure thereto.

In the shown embodiments, the lock 6000 may be an external lock. For example, the lock may be a padlock having a body housing a locking mechanism and a U-shaped shaft. In other embodiments, the lock 6000 may be tethered or otherwise integrated into the lockout system 1000, or include a deadbolt lock, a combination lock, and the like.

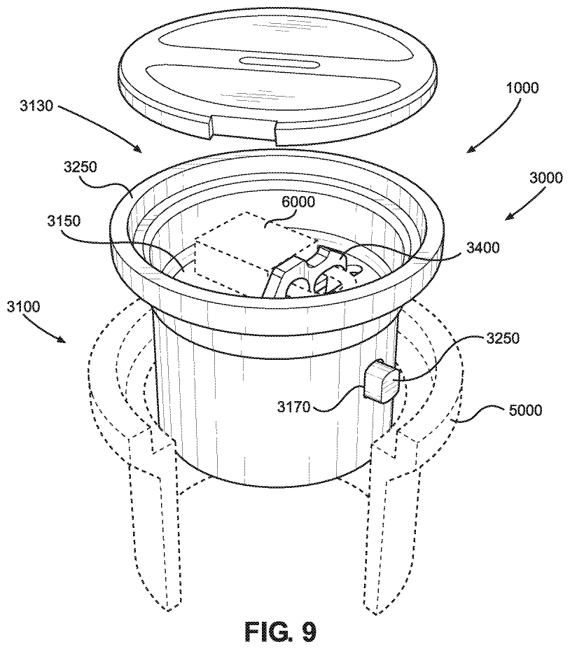

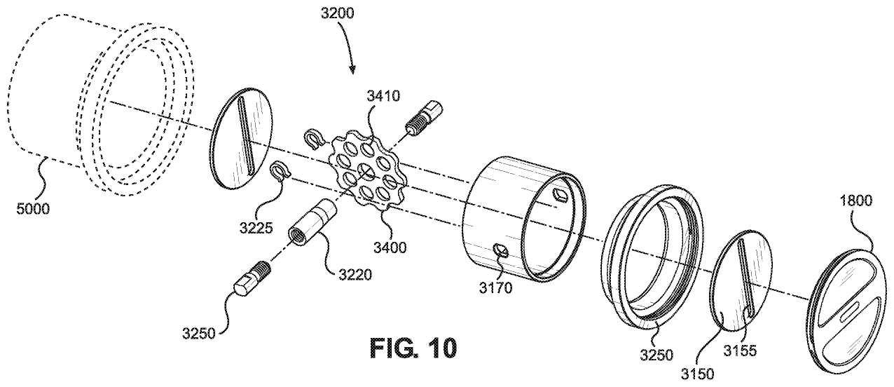

Referring specifically to FIGS. 9-12, there are shown views of the Montreal design embodiment 3000. In the shown embodiment, the pipe 5000 comprises a third style valve box. In this style, the pipe 5000 lacks an internal flange for securing therewith, and thus the lockout system 1000 utilizes one or more shafts 3250 for frictionally engaging the pipe 5000. The lockout system 1000 comprises a housing 3100 sized to be seated within the pipe 5000 to cover the open end 3130 thereof. The housing 3100 comprises a lip 3250 extending from a perimeter forming an open upper end 3130 and a plate 3150 seated within the lip 3250 and recessed from the open upper end 3130 of the lip 3250. The plate 3150 includes a slot 3155 sized to receive the twist member 3200, wherein the twist member 3200 is a dial 3400 generally oriented perpendicular to the plate 3150 and projecting to an upper side of the plate 3150.

In the shown embodiment, the dial 3400 is rotatable about a shaft housing 3220 such that the dial 3400 is configured to cooperatively rotate the shaft housing 3220 and cause the shaft 3250, operably connected within the shaft housing 3220, to selectively extend and retract. The shaft 3250 extends from the shaft housing 3220 and is adapted to frictionally bear against an interior of the pipe 5000 so as to semi-permanently affix the housing 3100 to the pipe 5000 in a retention configuration.

In the shown embodiment, the dial 3400 includes one or more dial apertures 3410 each adapted to receive a shank 6100 of a lock 6000 therethrough. Once the lock 6000 is received through one or more of the dial apertures 3410 disposed on the upper side of the plate 3150, the dial 3400 is cooperatively secured to the housing 3100 via the lock 6000 in a locked configuration so as to prevent independent rotation of the dial 3400.

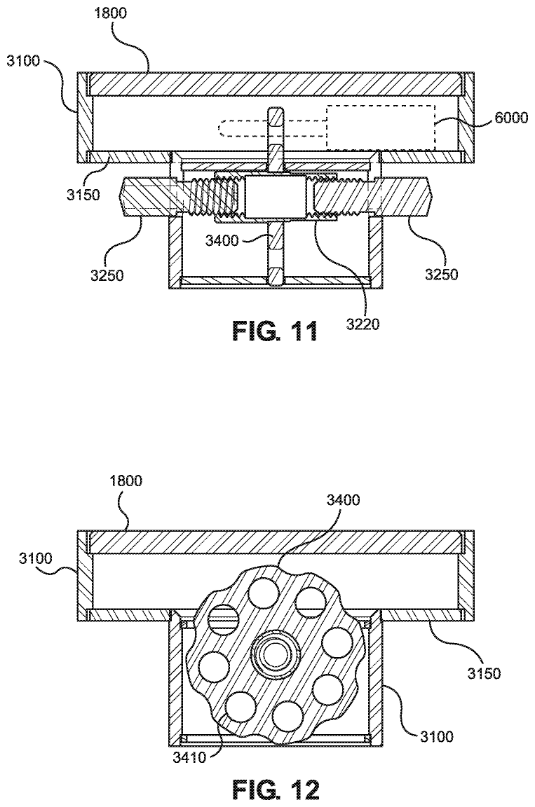

Referring specifically to FIGS. 11 and 12, the shaft housing 3220 is in a threaded connection with the shaft 3250, wherein the shaft 3250 extents through lateral apertures 3170 of the housing 3100 disposed on a lower side of the plate 3150. The dial 3400 is adapted to extend the shaft 3250 upon rotation in a first direction and retract the shaft 3250 upon rotation in an opposing second direction. In the shown embodiment, the housing 3100 is generally cylindrical and includes a pair of apertures 3170, mirroring one another on opposite sides thereof, that receives the shaft 3250 therethrough. The ends of the shaft 3250 are adapted to contact the interior of the pipe 5000 through the apertures and thereby prevent removal of the lockout system from the pipe.

The dial 3400 extends through the slot 3155, wherein the slot 3155 is centrally located on the plate 3150. In the illustrated embodiment, the shaft housing 3220 includes a horseshoe-shaped stop ring 3225 positioned on either side of the dial to secure the position thereof. In other embodiments, the dial and slot 3400, 3155 may be offset from the center of the plate 3150 to provide additional space for one or more locks 6000. In one embodiment, only a single dial aperture 3410 is entirely clear of the plate 3150 at a time. In this way, the rotation of the dial 3400 when locked is minimal as the shaft of the lock would abut the plate 3150. In the shown embodiment, the cover 1800 is removably affixed to the housing 3100, wherein the cover 1800 is adapted to isolate the dial 3400 from the exterior.

In one exemplary use, the Montreal embodiment 3000 of the lockout system 1000 is placed within a target pipe 5000, such as the third style pipe shown in FIG. 9. The user selectively rotates the dial 3400 to extend the shaft 3250 outward to engage the interior of the pipe 5000. Once secured, the user secures a lock 6000 to the dial aperture 3410 that extends upwards past the plate 3150. For example, the lock 6000 is a padlock that utilizes a shaft to be inserted into one of the dial apertures 3410. Once the lock 6000 is locked, the lock 6000 is fixed thereby preventing rotation of the dial 3400. The fixed dial also prevents the shaft housing 3220 and the shaft 3250 from moving. Once locked, the lockout system 1000 is secured to the pipe 5000 and access to the interior of the pipe 5000 is blocked.

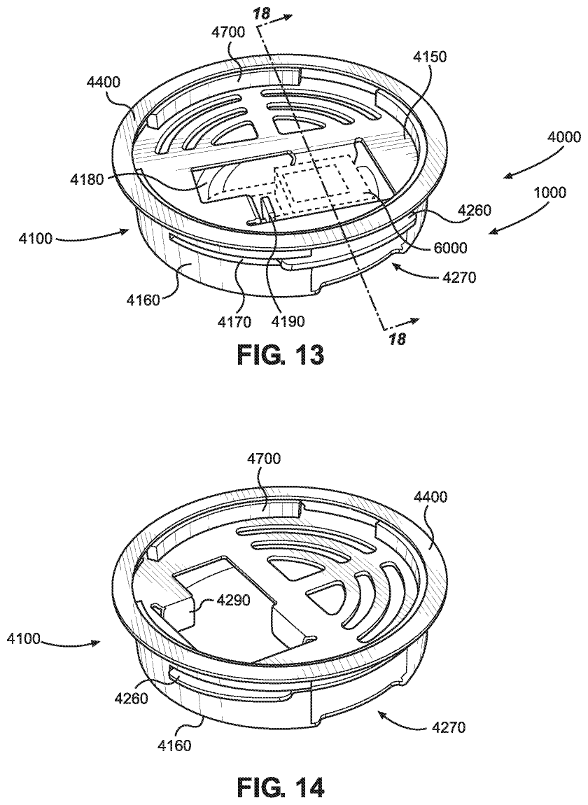

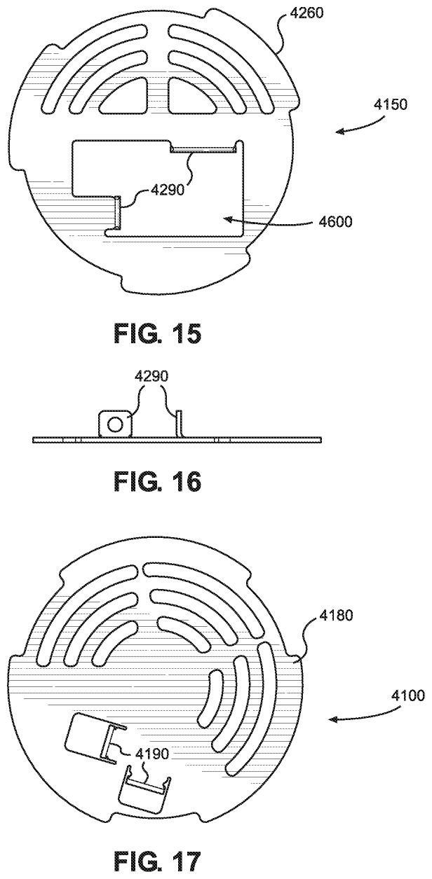

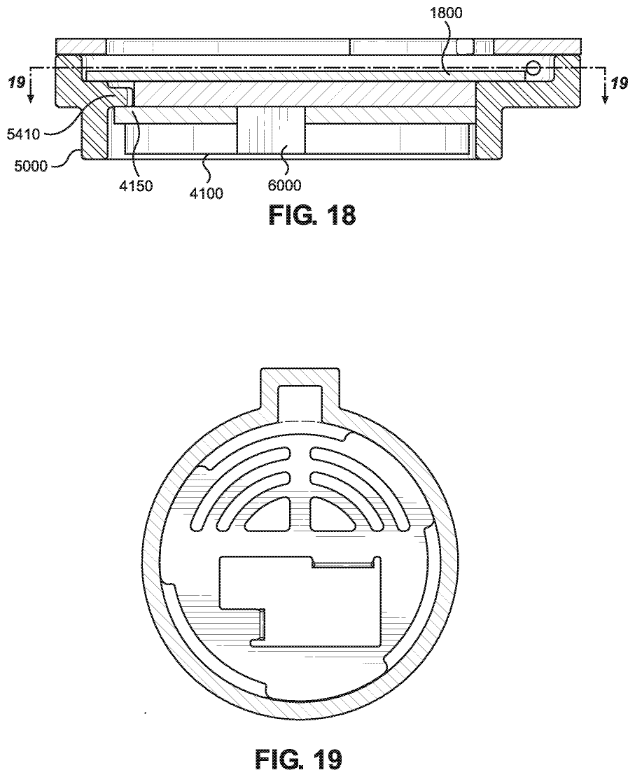

Referring specifically to FIGS. 13-19, there are shown views of the Winnipeg design embodiment 4000. In the shown embodiment, the pipe 5000 comprises a fourth style valve box. In this style, the pipe 5000 includes an internal flange or shoulder 5410 for securing therewith, and thus the lockout system 1000 utilizes one or more latches 4260 for positioning beneath the internal flange 5410 and a ring 4400 for positioning above the internal flange 5410 so as to sandwich the flange 5410, thus securing the lockout system 1000 to the pipe 5000.

In the shown Winnipeg design embodiment 4000, the lockout system 1000 comprises a housing 4100 sized to be seated within the pipe 5000 and to cover the open end thereof. The housing 4100 comprising an annular ring 4400 extending from a perimeter forming an open upper end and a top plate 4150 (also referred to herein as “twist member”) seated within the housing 4100 and recessed from the open upper end of the ring 4400. The housing 4100 includes a sidewall 4160 having one or more lateral slots 4170. In the shown embodiment, the housing 4100 includes three lateral slots 4170 general disposed at a fixed interval from each adjacent slot 4170. In alternative embodiments, the housing 4100 may include any number of lateral slots 4170 and each at any distance from each other.

The top plate 4150 includes one or more latches 4260 corresponding to the one or more lateral slots 4170, such that rotation of the top plate 4150 causes the one or more latches 4260 to retract into the corresponding lateral slot 4170 of the housing 4100 (see FIG. 13) or exit the corresponding lateral slot 4170 of the housing 4100 (see FIG. 14). The housing includes a channel 4270 extending from a lower end to the ring 4400, wherein the channel 4270 is sized to receive the shoulder 5410 of the pipe therein.

In the shown embodiment, the top plate 4150 is adapted to rotate between a release configuration (see FIG. 13) and a retention configuration (see FIG. 14). In the release configuration, the top plate 4150 is positioned within the slot 4170 allowing the shoulder 5410 to be positioned within the channel 4270. In the retention configuration, the latch 4260 is positioned within the channel 4270 to sandwich the shoulder 5410 between the ring 4400 and the latch 4260, thereby semi-permanently securing the housing 4100 to the pipe 5000. In one embodiment, the top plate 4150 comprises a lock aperture 4160 sized to receive the lock 6000.

The housing 4100 includes a lower plate 4180 positioned lower the top plate 4150, wherein the lower plate 4180 comprises one or more lower plate tabs 4190 for positioning the lock 6000. In the shown embodiment, the lower plate 4180 forms the lower portion of the housing 4100. The top plate 4150 comprises one or more top plate tabs 4290 that extend towards the lower plate 4180 such that the lock 6000 is seated on the lower plate 4180 and within a lock aperture 4600 between the bounds of the top plate and the lower plate tabs 4290, 4190.

In a locked configuration, the one or more of the top plate tabs and the lower plate tabs 4290, 4190are aligned and receive the shackle of the lock 6000 therethrough thereby causing the housing 4100 to be secured to the pipe 5000 and prevents access to the pipe and at the underside of the housing 4100. The lock aperture 4600 is sized to receive the lock 6000. In the shown embodiment, the lock 6000 is a padlock sized to fit in a particular orientation such that the shackle of the lock 6000 extends through both the top plate and the lower plate tabs 4290, 4190. In this way once locked, the lower plate 4180 (and housing 4100) and the top plate 4150 are cooperatively fixed. Once unlocked, the top plate 4150 is free to rotate within the housing 4100 between the release and retention configurations.

In the shown embodiment, the top plate tabs 4290 include a pair of tabs extending perpendicular from the top plate 4150 and oriented perpendicular to each other, as best shown in FIGS. 16 and 17. When the lock 6000 is positioned between the lower and top plate 4180, 4150, the top plate and the lower plate tabs 4290, 4190 acts to confine the lock 6000 within the lock aperture 4600. In this way, the lock 6000 cannot be manipulated such that the lower and top plate 4180, 4150 can be rotated from each other.

In the illustrated embodiment, as shown in FIG. 13, the lockout system further includes a spacer member 4700 adapted space the ring 4400 from the upper end of the top plate 4150. In this way, the spacer member 4700 allows for various size shoulders 5410 to fit within the channel 4270 and between the latch 4260 and the ring 4400.

The lockout system further includes a method of lockout and tagout of a pipe, the method including providing a lockout system comprising: a housing sized to be seated within the pipe to cover the open end thereof; a twist member for selectively configuring the lockout system between a release configuration and a retention configuration; wherein the twist member is independently rotatable from the housing to transition between the release and retention configurations; wherein the release configuration, the lockout system is adapted to be selectively positioned within the pipe and removed from the pipe; wherein the retention configuration, the lockout system is semi-permanently secured to the interior of the pipe via an engagement member, such that the housing substantially closes access to the pipe.

Moreover, the method includes positioning the lockout system within the pipe so as to cover the open end thereof; actuating the twist member such that the lockout system transitions from the release configuration to the retention configuration, wherein the retention configuration an engagement member is semi-permanently secured to the interior of the pipe and wherein apertures of the housing and the twist mechanism are aligned; and, securing a lock to the housing and the twist mechanism via the apertures in a locked configuration such that the lockout system is secured to the pipe and prevents access to the pipe and at the underside of the housing.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A lockout system for controlling access to a pipe, comprising:
a housing sized to cover an open end of the pipe;
a twist member for selectively configuring the lockout system between a release configuration and a retention configuration;
wherein the twist member is independently rotatable from the housing to transition between the release and retention configurations;
wherein the release configuration, the lockout system is adapted to be selectively positioned within the pipe and removed from the pipe;
wherein the retention configuration, the lockout system is semi-permanently secured to the pipe via an engagement member, such that the housing closes access to the pipe;
the housing and the twist member each comprising an aperture sized to align and receive a shackle of a lock wherein once received, the twist member is cooperatively secured to the housing via the lock in a locked configuration so as to prevent independent rotation of the twist member from the housing;
wherein the locked configuration, the lockout system is secured to the pipe and prevents access to the pipe.

2. The lockout system of claim 1, wherein the twist member comprises a handle disposed on an upper side and a shaft extends from a lower side of the twist member to a base plate,
wherein the engagement member is a dog plate having a shaft aperture, wherein the shaft extends through the shaft aperture and through a track of a frame plate;
wherein the dog plate is pivotally connected to the housing at a pivot such that the dog plate is adapted to rotate about the pivot;
wherein rotation of the handle causes cooperative rotation of the base plate, such that the dog plates extend and retract corresponding to the rotation.

3. The lockout system of claim 2, wherein the housing includes a sidewall having a slot sized to receive the engagement member therethrough.

4. The lockout system of claim 2, wherein:
the housing comprises a lip extending from a perimeter forming an open upper end and a top plate seated within the lip and recessed from the open upper end of the lip;
wherein the top plate includes a tab extending vertically therefrom, wherein the tab includes an aperture adapted to align with a handle having an aperture;
wherein each aperture is sized to receive a shackle of the lock;
the handle is operably connected to a pivot shaft that extends through the top plate and secures the handle to the top plate.

5. The lockout system of claim 1, wherein the handle comprises a straight portion and a pair of angled end portions, such that a pair of padlocks are adapted to fit on the upper sides thereof.

6. The lockout system of claim 1, wherein:
the twist member comprises a handle disposed on an upper side and a shaft extends from a lower side of the twist member to the engagement member, wherein the engagement member is an engagement bar;
wherein rotation of the handle causes rotation of the engagement bar.

7. The lockout system of claim 6, wherein the engagement bar is adapted to fit underneath an interior shoulder of a pipe thereby semi-permanently securing the housing to the pipe.

8. The lockout system of claim 6, wherein the housing comprises a lip extending from a perimeter forming an open upper end and a top plate seated within the lip and recessed from the open upper end of the lip;
wherein the top plate includes a tab extending vertically therefrom, wherein the tab includes a first aperture adapted to align with the handle having a second aperture;
wherein each first and second aperture is sized to receive a shackle of the lock and configure the lockout system in the locked configuration.

9. The lockout system of claim 8, further comprising a cover removably seated within the lip of the housing to conceal the handle.

10. A lockout system for controlling access to a pipe, comprising:
a housing sized to cover an open end of the pipe;
the housing comprising:
a plate seated within an open upper end of the housing;
the plate having a slot sized to receive a twist member, wherein the twist member is a dial generally oriented perpendicular to the plate and projecting to an upper side of the plate;
wherein the dial is rotatable and operably connected to a shaft such that the dial is configured to selectively extend and retract the shaft when rotated;
wherein the shaft is adapted to frictionally bear against an interior of the pipe so as to semi-permanently affix the housing to the pipe in a retention configuration;
wherein the dial includes one or more dial apertures each adapted to receive a shank of a lock therethrough;
wherein once the lock is received through one or more of the dial apertures disposed on the upper side of the plate, the dial is cooperatively secured to the housing via the lock in a locked configuration so as to prevent rotation of the dial.

11. The lockout system of claim 10, further comprising a cover is removably seated within the open end, wherein the cover is adapted to conceal the dial and the lock.

12. The lockout system of claim 10, wherein the dial is rotatable about a shaft housing that is in a threaded connection with the shaft, wherein the shaft extents through lateral apertures of the housing disposed on a lower side of the plate.

13. A lockout system for controlling access to a pipe, comprising:
a housing sized to cover an open end of the pipe;
the housing comprising a ring extending from a perimeter forming an open upper end and a top plate seated within the housing and recessed from the open upper end of the ring;
wherein the housing includes a sidewall having one or more lateral slots;
wherein the top plate includes one or more latches adapted to fit within the one or more lateral slots;
wherein the housing includes a channel extending from a lower end to the ring, wherein the channel is sized to receive a shoulder of a pipe therein;
wherein the top plate is adapted to rotate between a release configuration and a retention configuration;
wherein the release configuration the top plate is positioned within a slot of the one or more lateral slots allowing the shoulder to be positioned within the channel;
wherein the retention configuration a latch of the one or more latches is positioned within the channel to sandwich the shoulder between the ring and the latch thereby semi-permanently securing the housing to the pipe.

14. The lockout system of claim 13, wherein:
the top plate comprises a lock aperture sized to receive the lock;
the housing includes a lower plate positioned lower the top plate, wherein the lower plate comprises one or more lower plate tabs for positioning the lock.

15. The lockout system of claim 14, wherein:
the top plate comprises one or more top plate tabs that extend towards the lower plate such that the lock is seated on the lower plate and within the lock aperture and between the bounds of the top plate and the lower plate tabs;
wherein a locked configuration, one or more of the top plate tabs and the lower plate tabs are aligned and receive the shackle of the lock therethrough thereby causing the housing to be secured to the pipe and prevents access to the pipe and at the underside of the housing.

16. The lockout system of claim 15, further comprising a spacer member adapted space the ring from the upper end of the top plate.

17. A method of lockout and tagout of a pipe, the method comprising:
providing a lockout system comprising:
a housing sized to be seated within the pipe to cover the open end thereof;
a twist member for selectively configuring the lockout system between a release configuration and a retention configuration;
wherein the twist member is independently rotatable from the housing to transition between the release and retention configurations;
wherein the release configuration, the lockout system is adapted to be selectively positioned within the pipe and removed from the pipe;
wherein the retention configuration, the lockout system is semi-permanently secured to the interior of the pipe via an engagement member, such that the housing substantially closes access to the pipe;
positioning the lockout system within the pipe so as to cover the open end thereof;
actuating the twist member such that the lockout system transitions from the release configuration to the retention configuration, wherein the retention configuration an engagement member is semi-permanently secured to the interior of the pipe and wherein apertures of the housing and the twist mechanism are aligned.

18. The method of claim 17, further comprising:
securing a lock to the housing and the twist mechanism via the apertures in a locked configuration such that the lockout system is secured to the pipe and prevents access to the pipe and at the underside of the housing.

19. The method of claim 18, wherein the twist member is a dial operably connected to a shaft.

20. The method of claim 18, wherein the twist member is a top plate having one or more latches corresponding to one or more lateral slots disposed within the housing and adapted to align therewith.
